(19) United States
(12) Patent Application Publication
(10) Pub. No.: US 2008/0113670 A1
(43) Pub. Date: May 15, 2008

(54) METHOD FOR MANAGING A LIST OF NEIGHBORING CELLS IN A CELLULAR TELECOMMUNICATIONS NETWORK

(75) Inventors: Daniel Dufour, Blainville (CA); Philip Cochran, Poway, CA (US); Nitin Bhalla, San Diego, CA (US)

Correspondence Address: ERICSSON CANADA INC.;PATENT DEPARTMENT, 8400 DECARIE BLVD., TOWN MOUNT ROYAL, QC, H4P 2N2, omitted

(73) Assignee: TELEFONAKTIEBOLAGET LM ERICSSON (PUBL), Stockholm (SE)

(21) Appl. No.: 11/559,627

(22) Filed: Nov. 14, 2006

(51) Int. Cl. H04Q 7/20

(52) U.S. Cl. 455/436

(57) ABSTRACT

A method and a radio network manager (RNM) for managing a list of target cells associated to a source cell in a telecommunications network. The RNM comprises an input/output (I/O) unit for receiving a file containing at least one record associated to the source cell from a base station controller (BSC). The RNM also comprises a processor for determining for each record whether a target cell is missing from the list of target cells identifying the target cell as missing from the list of target cells, if the target cell is missing from the list of target cells. The RNM determines for each record whether a target cell is excessive from the list of target cells and removes the target cell, if the target cell is excessive from the list of target cells. Afterwards, the RNM sends an updated list to the BSC.

### TECHNICAL FIELD

The invention relates to the field of telecommunications network and, more particularly, to techniques for improving handoff of a mobile station in a telecommunications network.

### BACKGROUND

A geographical area served by a telecommunications network is divided into cell areas in which radio base stations, also sometimes referred to as base transceiver stations, provide radio coverage to mobile stations (MSs) operating in said cell areas. A MS can be any Personal Digital Assistant (PDA), mobile terminal, mobile telephone that enables mobile station mobile subscribers to communicate voice, data and/or multimedia information over the cellular radio communication network. Each radio base station (BS) may be equipped to service one or more cells.

A MS may be assigned a radio communication channel dedicated for communication between the MS and the cellular network e.g. when receiving or making a phone call. In a cellular radio communication system based on Code Division Multiple Access (CDMA) technology a dedicated radio communication channel need not only to be supported by a single serving cell at each given moment of time, but may on the contrary be supported by several cells using so called macrodiversity which provides increased radio transmission quality.

The CDMA technology is described in Interim Standard-95 (IS-95) published by the Telecommunications Industry Association (TIA). IS-95 is often referred to as second generation (2G) wireless communications and the UTRAN FDD mode (also referred to as Wideband CDMA). The CDMA technology is also the basis for third generation (3G) telecommunications network such as CDMA2000 and CDMA 1X networks. After a couple of revisions, IS-95 was superseded by the IS-2000 standard. This standard was introduced to meet some of the criteria laid out in the International Mobile Telecommunications-2000 (IMT-2000) specification, which is the global standard for 3G wireless communications.

Due to the possibility of using more than one cell to serve a dedicated radio communication channel, these cellular radio communication networks also enables so called soft handover. In order to support handover in networks using CDMA technology, MSs are required to perform measurements on downlink transmissions, i.e. from the cellular network to the MSs. The measurement results are reported back to the cellular network and are used for making a decision on which cell is best suited to serve a MS.

The MS searches for pilots on the current CDMA Frequency Assignment to detect the presence of CDMA Channels and to measure their strengths. When the MS detects a pilot of sufficient strength that is not associated with any of the Forward Traffic Channels assigned to it, it sends a Pilot Strength Measurement Message (PSMM) to a BS. The BS can then assign a Forward Traffic Channel associated with that pilot to the mobile station and direct the MS to perform a handoff.

A similar measurement is also made by a MS in idle mode as the MS roams from a first cell area, for example, to a second cell area. Such a process for selecting a new cell is referred to as a cell re-selection process. In this case the neighbor cell list broadcast on the control channel of the serving BS is specifying which channels to measure on.

Whenever the signal strength between the MS and a target BS increases the MS hands off to the target BS located in a target cell in the list of cells. However, since the neighbor list is often based on the network topology represented by the geographic proximity of cells, a more appropriate target BS may be absent from the neighbor list.

For that reason, even though a MS is provided with a list of neighboring cells, a call may be dropped. For example, a call may be dropped if a strong pilot has been omitted from the cell neighbor list. The MS may detect and report the pilot, but a handoff cannot be granted because the BS is not configured to determine a unique cell based on the pilot report.

Furthermore, a call may also be dropped, if a useless cell takes up room in the neighbor list provided to the MS. This can cause more appropriate cells to which the MS can be handed off to be truncated from a cell neighbor list.

Thus, it would be interesting to determine the appropriate cells in a neighboring list provided to a MS. The invention provides a solution to this problem.

### SUMMARY

It is a broad aspect of the present invention to provide a method for managing a list of target cells associated to a source cell in a telecommunications network, the method comprising the steps of:

receiving at a radio network manager from a base station controller (BSC), a file containing at least one record associated to the source cell;

determining for each record whether a target cell is missing from the list of target cells;

if the target cell is missing from the list of target cells, the radio network manager identifies the target cell as missing from the list of target cells;

determining for each record whether a target cell is excessive from the list of target cells;

if the target cell is excessive from the list of target cells, the radio network manager removes the target cell; and

sending an updated list of target cells for the source cell from the radio network manager to the BSC.

It is another broad aspect of the present invention to provide a radio network manager for managing the list of target cells associated to the source cell, the radio network manager comprising:

an input/output (I/O) unit for receiving a file containing at least one record associated to the source cell from a base station controller (BSC);

a processor for:

determining for each record whether a target cell is missing from the list of target cells;

identifying the target cell as missing from the list of target cells, if the target cell is missing from the list of target cells;

determining for each record whether a target cell is excessive from the list of target cells;

removing the target cell, if the target cell is excessive from the list of target cells; and

sends from the I/O unit an updated list of target cells to the BSC.

### BRIEF DESCRIPTION OF THE DRAWINGS

The foregoing and other aspects, features, and advantages of the invention will be apparent from the following more particular detailed description as illustrated in the accompanying drawings in which reference characters refer to the same parts throughout the various views. The drawings are not necessarily to scale, emphasis instead being placed upon illustrating the principles of the invention.

FIG. 1 is a schematic diagram illustrating a cellular telecommunications network for providing services to an end-user in accordance to the invention.

FIG. 2 is a schematic diagram illustrating the association between a radio network manager and a base station controller in a radio telecommunications network in accordance to the invention;

FIG. 3A is a schematic diagram illustrating a measurement file stored in the BSC in accordance to the invention;

FIG. 3B is a schematic diagram illustrating an example of a record related to handoff event stored in the BSC in accordance to the invention;

FIGS. 3C and 3D are tables illustrating lists of recommended target cells and updated target cells stored in the RNM in accordance to the invention;

FIGS. 3E and 3F are tables illustrating lists of excessive target cells and merged neighbors target cells stored in the RNM in accordance to the invention;

FIG. 4A is a flow chart of a method for managing a list of target cells in accordance to the invention;

FIG. 4B is a flow chart of a method for determining missing target cells in accordance to the invention;

FIG. 4C is a flow chart of a method for determining excessive and non-excessive target cells in accordance to the invention; and

FIG. 5 is an example of a set of rules for removing a target cell in accordance to the invention.

### DETAILED DESCRIPTION

In the following description, for purposes of explanation and not limitation, specific details are set forth such as particular architectures, interfaces, techniques. In order to provide a thorough understanding of the present invention. However, it will be apparent to those skilled in the art that the present invention may be practiced in other embodiments that depart from these specific details. In other instances, detailed descriptions of well known devices, circuits, and methods are omitted so as not to obscure the description of the present invention with unnecessary detail.

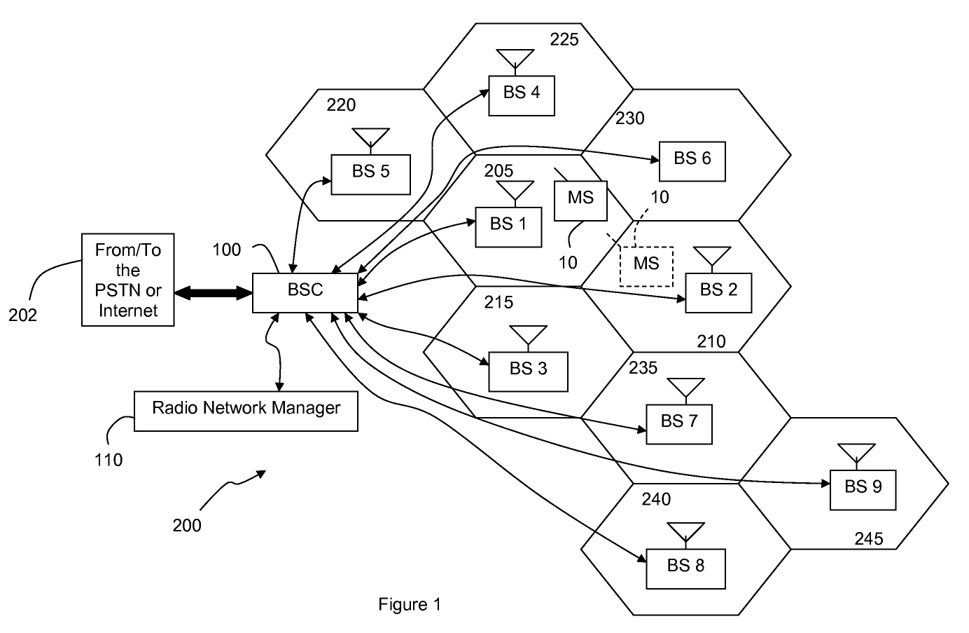

Reference is now made to FIG. 1, which is a schematic diagram illustrating a cellular telecommunications network 200 for providing voice and data services to a mobile station (MS) 10 in accordance to the invention.

The network 200 is divided in cells. A partial view of the network 200 is provided in FIG. 1. Thus, cells 205 to 245 are illustrated. A base station (BS) is located in each cell for providing radio access to the telecommunications network 200 and ultimately voice and data and multimedia services to the MS 10. BS 1 to BS 9 are located in cells 205 to 245 respectively. The BSs of network 200 are associated to a base station controller (BSC) 100. The BSC 100 can be used as stand alone as shown in FIG. 1 or physically collocated with a BS (not shown). Thus, each BS shown in FIG. 1 may comprise a BSC such as BSC 100. The BSC 100 is responsible for radio resource allocation to a MS, frequency administration and handover between base stations controlled by the BSC 100. In FIG. 1, the BSC 100 manages its associated BS (BS 1, BS 2 and BS 3) and establishes communication channels for MSs located in cells served by these BSs. The BSC 100 is ultimately connected to the rest of the network 200, which then provides connection to other network such as the Public Switched Telephone Network (PSTN) or the Internet 202. As defined in interim Standard-2000 (IS-2000), published by the Telecommunications Industry Association, each BS dedicates a significant amount of output power to a pilot channel, which is an unmodulated PN sequence. Each BS sector in the network 200 is assigned a PN offset. There is no data carried on the forward pilot. With its strong autocorrelation function, a pilot allows MSs to determine system timing and distinguish different BSs for handoff.

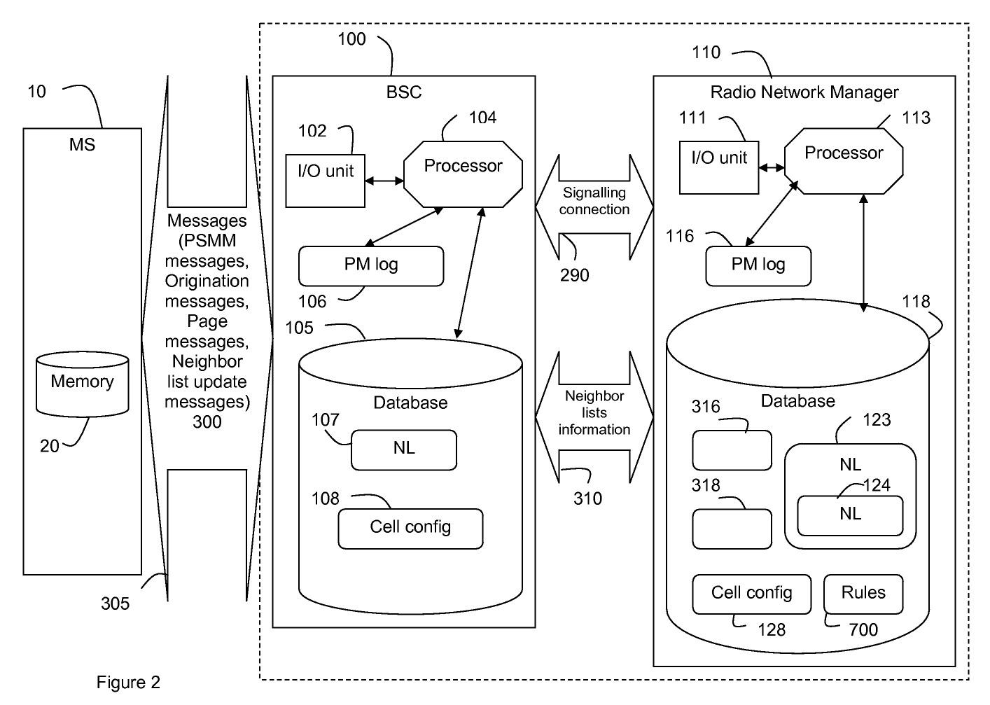

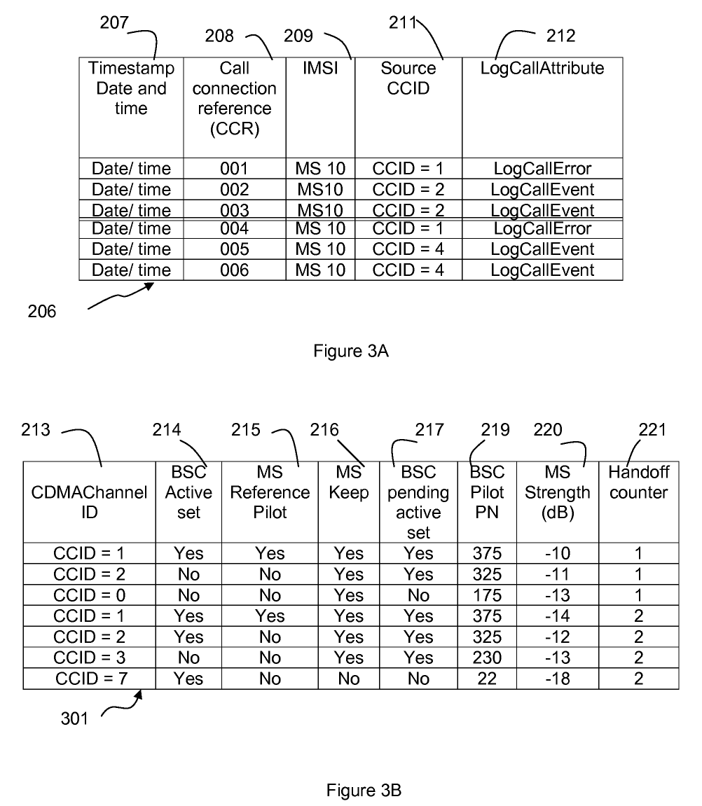

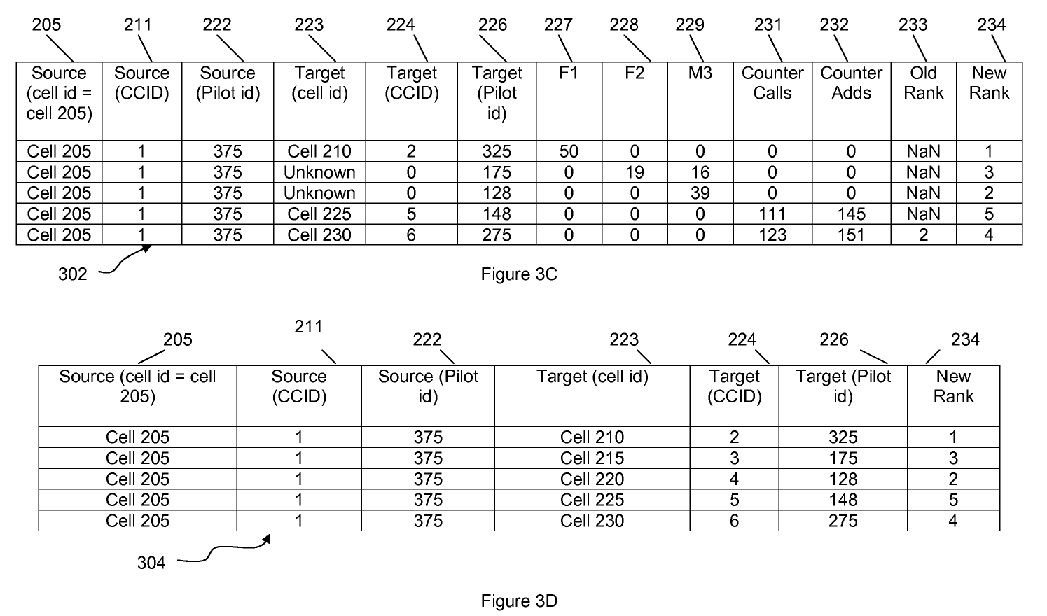

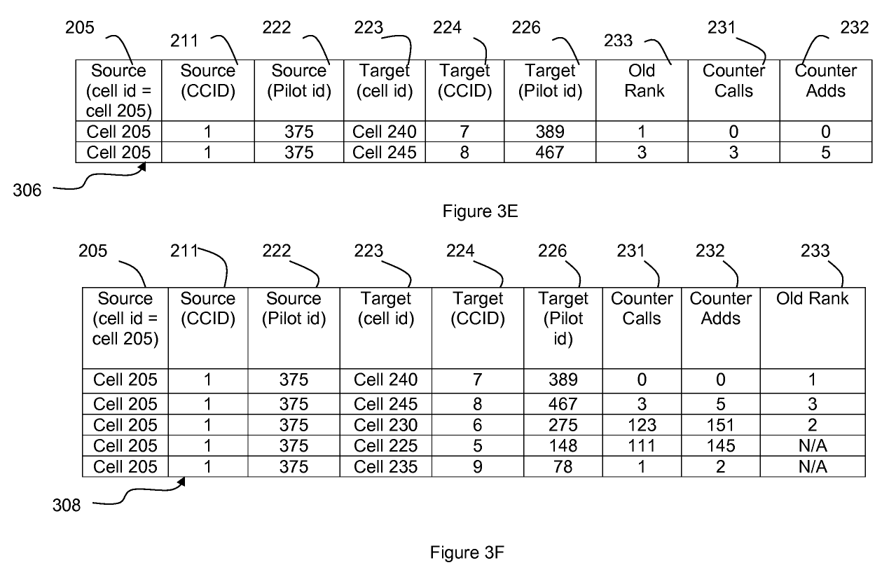

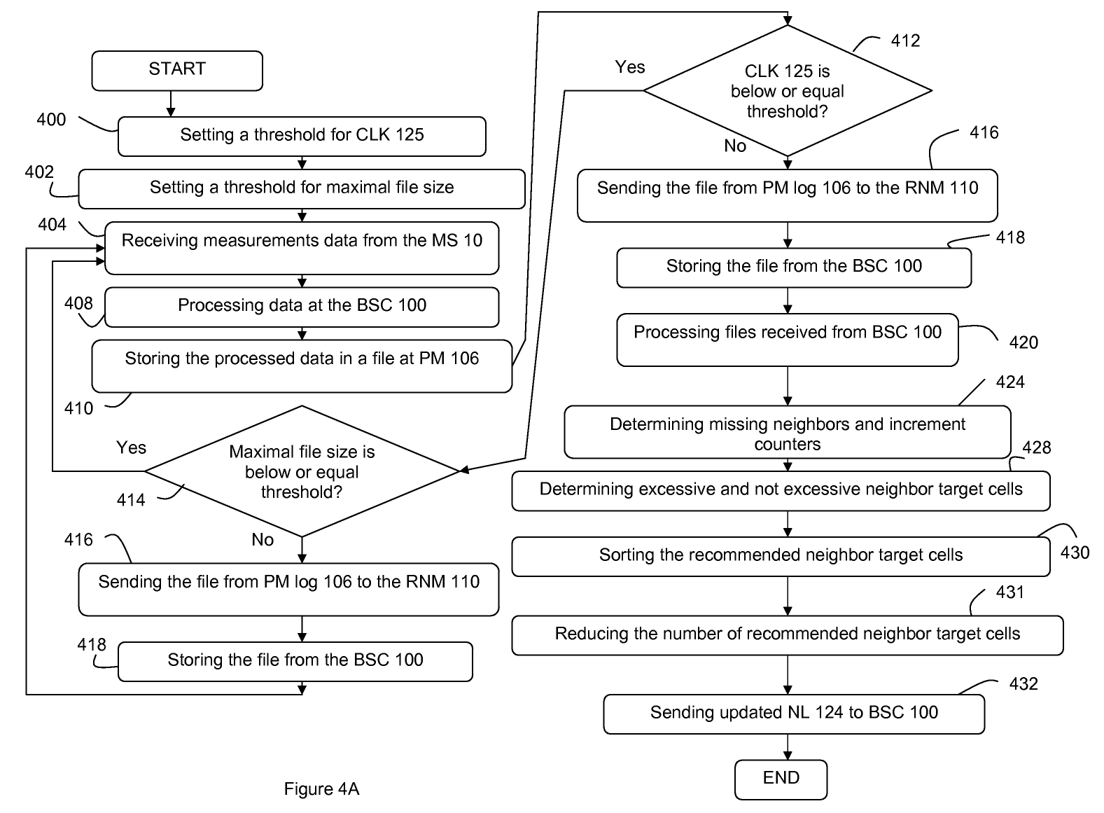

Reference is now made to FIG. 2, which is a schematic diagram illustrating the association between, the MS 10, the BSC 100 and a Radio Network Manager (RNM) 110 in the network 200 in accordance to the invention. Reference is also made to FIG. 3A to 3D, which are lists stored at the BSC 100 and the RNM 110 in accordance to the invention. The MS 10 can be any Personal Digital Assistant (PDA), mobile terminal, mobile telephone that enables mobile station mobile subscribers to communicate voice, data and/or multimedia information over the cellular radio communication network 200. The MS 10 performs measurement on pilots in the network 200 and further sends the measurements to the BSC 100 via a serving BS. The MS 10 sends and receives messages from network entities in the network 200. The MS 10 also comprises a memory 20 for storing pilots on which the MS 10 performs measurements. The MS 10 to perform appropriate measurements on pilots and further provide them to a serving BS and ultimately to the associated BSC 100.

The BSC 100 comprises an input/output (I/O) unit 102 for receiving information from the network 200 and for sending information to the network 200 and ultimately the PSTN or the Internet, a processor 104 for operating the BSC 100, a database 105 for storing information that can be accessed by the processor 104. The database 105 stores a cell configuration 108 of a part of the network consisting of cells for which the BSC 100 controls the BSs. The cell configuration 108 is a listing of all BSs, their communication channels and the associated pilots.

The BSC 100 stores the performance measurements made by MSs in the network 200 in a Performance Measurements (PM) storage 106. Performance measurements are provided by the MSs e.g. MS 10 on a radio link (signaling connection 305). After receiving performance measurements, the processor 104 of BSC 100 adds information in the PM 106. An example of the performance measurements stored in PM 106 is provided in table 206 of FIG. 3A.

The RNM 110 comprises an input/output (I/O) unit 111 for receiving messages from the network 200 and for sending messages to the network 200, a processor 113 for operating the RNM 110, a database 118 that can be accessed by the processor for storing files of call flows in the network 200 such as table 206 that may be sent from the BSC 100 to the RNM 110. The table 206 can be sent to the RNM 110 based on the File Transfer Protocol (FTP). The processor 113 analyzes received files from different BSCs in the network 200 and also analyzes stored data at the database 118. The database 118 stores a cell configuration 128. The cell configuration 128 is a listing of identifiers of all BSs, their communication channels identifiers and associated Pilot_PN identifiers. The databases 105 and 118 may be any persistent memory such as a file system, a Read-Only Memory (ROM) or a Structured Query Language (SQL) database. The processors 104 and 113 can be hardware, software, or any combination thereof. The RNM 110 further manages a neighbor list (NL 122) of target cells for each cell associated to the BSC 100 in network 200 and updates the NL107 stored at the BSC 100 by transmitting updated data on the link 310.

Since a MS can be served by a first cell before handing off to a second cell, it can be understood that the first cell is the reference cell and the second cell the target cell. Thus following the handoff of the MS from the first cell to the second cell, the first cell which is the reference cell becomes a target cell and the second cell becomes the reference cell.

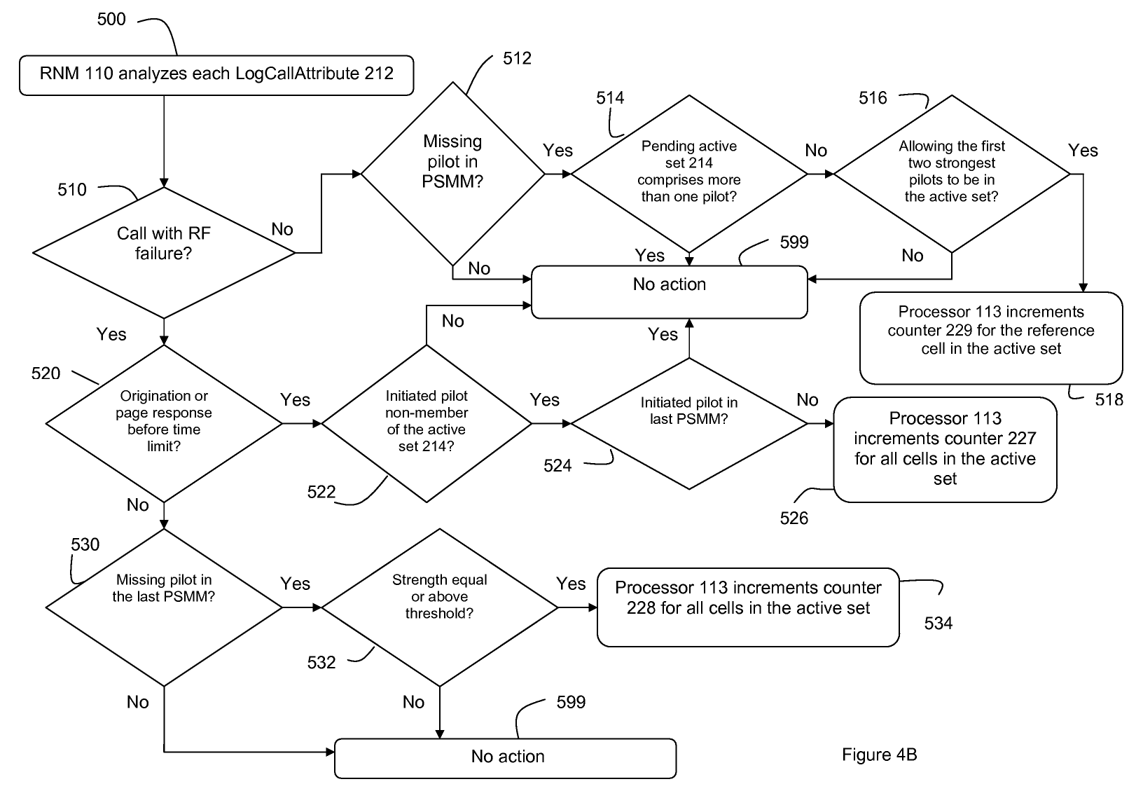

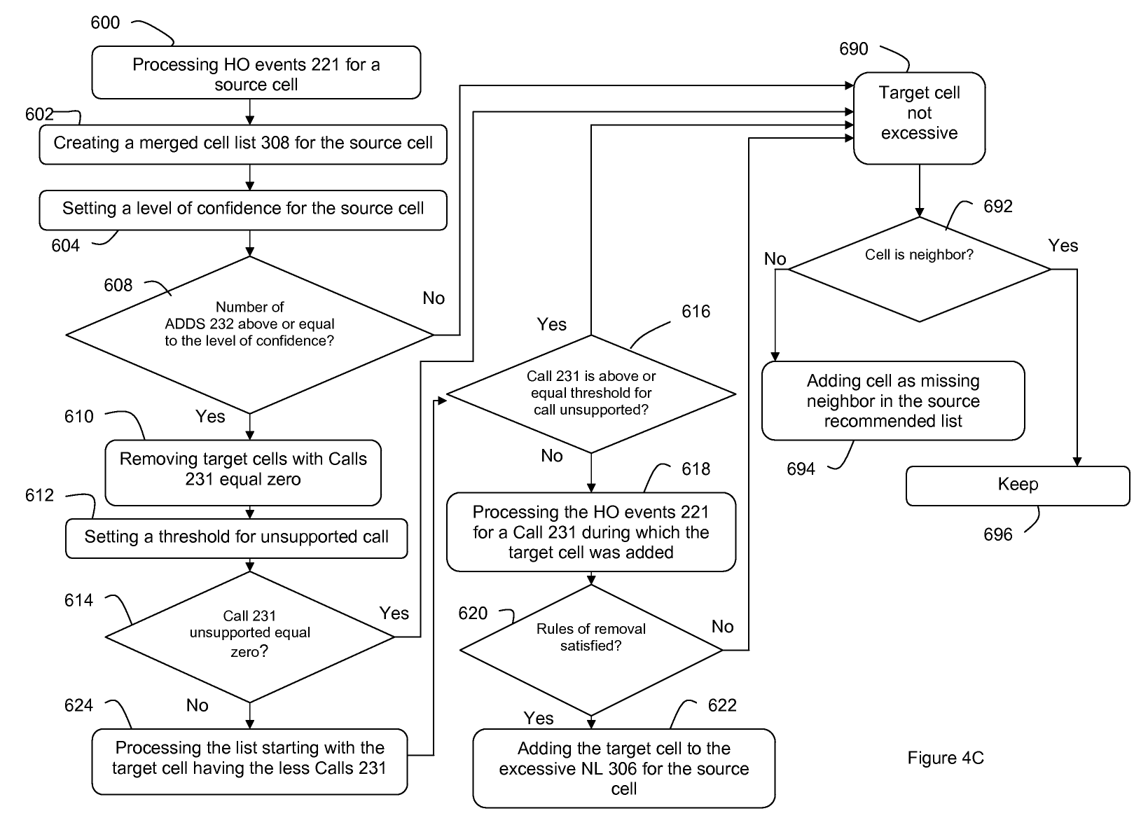

Reference is now made to FIG. 4A, which is a flow chart of a method for managing the list of neighboring target cells (NL 123) in accordance to the invention. At step 400, the RNM 110 sets a first threshold value for a timer CLK 125 and starts the timer. The first threshold for the timer CLK 125 indicates the maximal time for collecting data at the BSC 100. At step 402, the radio network manager sets a second threshold value for measurement file maximal size and starts a load counter (not shown) for measuring the file size. Alternatively, the RNM 110 can send an indication on connection 290 to the BSC 100 and for starting a clock (CLK) 125 for duration of data collection.

At step 404, the BSC 110 receives messages consisting of Origination messages, Page response messages, and call failure messages. The messages comprises among other things information consisting of Pilot Strength Measurement Messages (PSMMs) for informing the serving BSC 100 of a significant change in the strength of a detectable pilot.

At step 408, the BSC 100 processes measurements received from the MS 10, adds related information and stores the combination of measurements and measurements information in table 206 at the PM 106 (step 410).Then, for each LogCallAttribute 212, the BSC in table 206 adds a timestamp 207 for indicating the time of reception of the LogCallAttribute 212, a Call Connection Reference (CCR) 208 for identifying a call in which the MS 10 is involved, the identity 209 of the MS 10 such as a International Mobile Station Identity (IMSI) and a Source CCID 211 for identifying the assigned communication channel. A LogCallAttribute 212 is one of a LogCallEvent and a LogCallError. The LogCallEvent identifies the events occurring during a call for a particular MS such as the MS 10 when the MS originates a call (Origination message), responds to a page request (Page response message), and a handoff processing (processed PSMM 300). On the other hand, the LogCallError identifies when a call attempt ended with an error. At the end of any call attempt where an error has occurred, the current error code value, the data from the last processed PSMM record 300 before the call attempt is ended with an error and the pilot active set (not shown) at the time of the call drop are logged.

The BSC 100 stores a record similar as the table 301 of FIG. 3B for each processed PSMM after the completion of the Handoff Granting algorithm processing. The stored record at table 301 shall include a handoff counter 221 (an identifier for each handoff attempt, unique within a single call), a set of data from the PSMM, a set of data added by the BSC 100 and a set of data from the PSMM received from the MS for each reported pilot. The set of data added by the BSC 100 for each reported pilot shall consist of, a calculated Pilot_PN 219, a CDMA Channel identifier (CCID) 211, a flag 217 to indicate if the reported pilot is included in the pending active set produced by the Handoff Granting algorithm, and a flag 214 to indicate if the reported pilot 219 is in the current active set when the PSMM is received. The set of data from the PSMM for each reported pilot shall consist of, a flag 215 to indicate if the pilot is the reference pilot, a flag 216 if the pilot is reported as a KEEP pilot and a pilot strength 220. When a pilot reported in the PSMM can not be mapped to any pilot in the neighbor lists of the active set pilots, the BSC identifies this missing pilot with CCID 211 of zero. It can be understood that a processed PSMM record can comprise more than one reported pilot for the same handoff counter 221.

The BSC 100 performs steps 404 to 410 until the predetermined CLK 125 is reached (step 412) or until a maximal file size for a measurement file is reached (step 414). If the first value is below or equal to the first threshold value for CLK 125 (step 412), the BSC 100 determines whether the second threshold value for the maximal file size is below or equal the maximal file size (step 414). When, at step 412, the processor 104 determines that the first threshold value for CLK 125 is above the predetermined threshold or when at step 414 processor 104 determines that the second value for a maximal file size is above the second threshold value, the BSC 110 sends the content of the PM 106 consisting of the latest measurement file similar as the table 206 to the RNM 110 (step 416). The RNM 110 stores the latest measurement file received from the BSC 100 in the PM 116 (step 418) and processes the measurement files (step 420) when the CLK 125 is reached.

The RNM 110 is then able to determine missing target cells (step 424) and excessive target neighbors cells (step 428) from merged NL 308. The RNM 110 also sorts the recommended neighbor list (NL) 123 (step 430) and reduces the number of recommended target cells to a defined number of maximum target neighbor cells (step 431) before sending an updated NL 124 to BSC 100.

More particularly, the RNM 110 uses the recommended neighbor list (NL) 123 and builds the updated list NL 124. The NL 124 contains a neighbor list for each cell of each BSC associated to the RNM 110. The neighbor list for BSC 110 is NL 124. The updated NL 124 is a subset of NL 123 without the missing counters 227, 228 and 229, Calls 231 and Adds 232. The unknown target cells in the recommended NL are replaced automatically by the RNM 110 or by other means involving the RNM 110 in the updated NL 124 with the most probable target cell id matching the unknown target cell Pilot_PN in the vicinity of a source cell. At step 432, the RNM 110 sends an updated NL 124 to the BSC 100. Following this, the BSC 100 updates the NL 107 with NL 124.

Missing Neighbors in Neighbor Cell List

Reference is now made to FIG. 4B, which is a flow chart describing a method for determining missing neighboring target cells from the list NL 123 in accordance to the invention. Reference is also made to FIG. 3A, which is a schematic diagram illustrating a measurement file 206 stored in the BSC 100 in accordance to the invention. FIG. 3A is only a part of the content of the PM 106. The determination of missing target cells at step 424 can be done in several manners. At step 424, the RNM 110 processes each LogCallAttribute 212. The LogCallAttributes 212 are sorted in a chronological order and per MS identifier (e.g. International Mobile Subscriber Identity (IMSI)).

Before determining missing neighbors target cells, the RNM 110 analyzes each LogCallAttributes 212 (step 500). A first way for determining a missing neighbor is when a call fails for a MS due to an error that indicates an RF failure (step 510) and the MS re-originates the call after a short period of time from a missing pilot of a missing neighbor cell and the missing pilot was not reported in the PSMM data For example, if the MS 10 is located in cell 205, which is considered to be the source cell and is currently on a call with another party (not shown) and a radio (RF) failure occurs then the MS 10 re-originates the call after a short predetermined period of time from a pilot of another cell such as pilot 325 of cell 210 by sending either an Origination Message or a Page Response Message to the BS 2, the pilot 325 of cell 210 may be considered missing.

If at step 522, the pilot 325 from which the call was originated is not a member of the active set 214 at the time of the call drop and is not reported in the last processed PSMM 300 record before the call attempt is ended with an RF failure error (step 524), the processor of the RNM 110 identified the pilot 325 as missing. Also, to avoid false detection, verification is made at the RNM 110 to ensure that the initiating pilot is not a member of the neighbor cell list of any member in the active set at the time of the call drop (not shown). The RNM 110 compares the first LogCallAttribute 212 of the stored failure IMSI and the LogCallAttribute 212 after failure of event type Origination or Page Response (LogCallEvent 212) of the next CCR for the same IMSI. If the initiating pilot found in the LogCallAttribute 212 after failure is reported missing, the missing pilot is added to the recommended NL 123 of each member of the active set 214 of the stored failure IMSI. At step 526, a first missing counter 227, which tracks the number of times a missing pilot is not reported in a PSMM while an RF failure occurred in a source cell, is incremented. In particular, the RNM 110 increments the first missing counter 227 for each source cell member of the active set 214. If the pilot 325 has been reported in the PSMM data or if the pilot 325 is a member of the active set 214 there is no action performed by the RNM 110 (step 599).

A second way for determining a missing pilot in a neighbor list is when a missing pilot is reported in the PSMM data and subsequently an RF failure occurs. At step 510, the RNM 110 determines that a call error due to an RF failure occurred, but the MS 10 does not re-originate the call before the time limit (step 520). Before the call failure, if a missing pilot (identified with a CCID 213 of zero) is reported in the last processed PSMM 300 record of a LogCallError 212 (step 530) and if the missing pilot strength is above or equal to a predetermined threshold (step 532), the missing pilot is added to the recommended NL 123 of each member of the active set of the stored failure IMSI. At step 534, a second missing counter 228, which tracks the number of times a missing pilot is reported in the PSMM data and a RF failure occurred in a source cell is incremented. If there is no missing pilot in the PSMM data or if the missing pilot is below the predetermined threshold, no action is performed by the RNM 110 (step 599).

A third way for determining a missing pilot in a neighbor list is when a missing pilot is reported in the PSMM data and no RF failure occurs. At step 510, the RNM 110 determines that no call error due to an RF failure occurred. However, at step 512, the RNM 110 detects a missing pilot in the process PSMM record 300 of a LogCallEvent 212 of event type Handoff processing for a CCR without RF failure. Thus, if the number of pilots in the pending active set 214 is one (step 514), and if a predetermined parameter allows to constantly have the first two strongest pilots to be in the active set without having the second pilot verified to meet strength criteria (step 516), the RNM 110 increments a third counter 229 which tracks the number of times a missing pilot is reported in PSMM data and no failures occurs in a source cell (step 518). The missing pilot is added to the recommended NL 123 of the reference pilot 215, if the counter 229 is above or equal to a predetermined threshold. In table 301 of FIG. 3B, the reported pilot with CCID 213 value equal to zero and PN value 175 is added to the recommended NL 123 of the reference pilot if that pilot has been encountered missing in CCRs without RF failure at least the predetermined minimum amount of time in the PSMM data.

When the active set 214 comprises one or more pilots, the neighbor lists of all active set members 214 are combined into one neighbor list, which consist in a merged neighbor list of target cells 308. The reference pilot may add a pilot from this list that is not in its own neighbor list.

Reference is now made to FIGS. 3C and 3D are tables illustrating lists of recommended target cells (table 302) and updated target cells (table 304) stored in the RNM 110 in accordance to the invention. Table 302 is only an example of a part of NL 123 for cell 205 and table 304 is only an example of a part of NL 124 for cell 205. Table 302 includes the source CCID 211 (CCID=1), a source pilot ID 222 (pilot PN 375), a target cell ID 223, a target CCID 224 and a target pilot ID 226. At step 430, the target cells in the recommended NL 123 can be sorted and ranked based on the missing counters 227, 228 and 229 for missing pilots of target cells. The sorting can be based first on the descending order of the compilation of missing counters 227, 228 and 229 (i.e. F1 227+F2 228+M3 229). The list of FIG. 3C can also comprises two additional counters: Adds 232 and Call 231. The recommended (NL 124) (table 302) can be sorted in second order by total number of Adds 232 and in third by ascending order of the ranking order in the existing neighbor list (NL 107). The counter Calls 231 is the compilation number of calls where the candidate target was added to the pending active set when the source was the reference pilot. The counter Adds 232 is the number of time each candidate pilot was added to the pending active set 217 when the source cell was the reference cell 215. The table 302 also includes a ranking (old rank 233) before the sorting before step 430 and a ranking (new rank 234) following the sorting performed by the processor 113 at step 430.

Excessive Neighbors in Neighbor Cell List

Reference is now made to FIG. 4C, which is a flow chart of a method for determining excessive target neighbor cells in accordance to the invention. Reference is also made to FIGS. 3E and 3F, which are tables illustrating lists of excessive target cells (table 306) and merged neighbors target cells (table 308) for a source cell stored in the RNM in accordance to the invention. Tables 306 and 308 are a part of NL 316 and 318 respectively. NL 316 and 318 contain excessive NLs for all cells of the network 200 are stored in database 118. At step 600, the RNM 110 processes each HO events 221 for a source cell. At step 602, the RNM 110 creates the merged neighbor list 308 of target cells from for a source cell. For example, at FIG. 3F the merged NL 308, the source cell is cell 205. Following this, the RNM 110 sets the level of confidence of each source cell based on a predetermined threshold, which is the minimum amount of Adds 232 that a source cell must have encountered before considering removing a neighbor cell from the source cell NL 308 (step 604). If the total number of Adds 232 from the source cell 205 to any target is above or equal to the confidence level threshold (step 608), the confidence level is set high for these source cell and the RNM 110 removes all target cells members of the neighbor list of each source cell for which the counter Calls 231 equals to zero (step 610). Otherwise, the confidence level is set to low (step 608) and RNM 110 cannot remove any neighbors from the neighbor list of those source cells and identifies all target cells from the merged NL 308 as not excessive (step 690).

After removing the neighbor cells without been involved in any calls the RNM 110 sets a threshold for the maximum call that will not be supported by all neighbors when determining the recommended NL 124 (step 612). Generally, the maximum number of unsupported calls represents not more than 1% or 2% or in the more conservative case 0% of the total number of calls that used the source as a reference pilot. The maximum percentage of unsupported calls is a predetermined parameter.

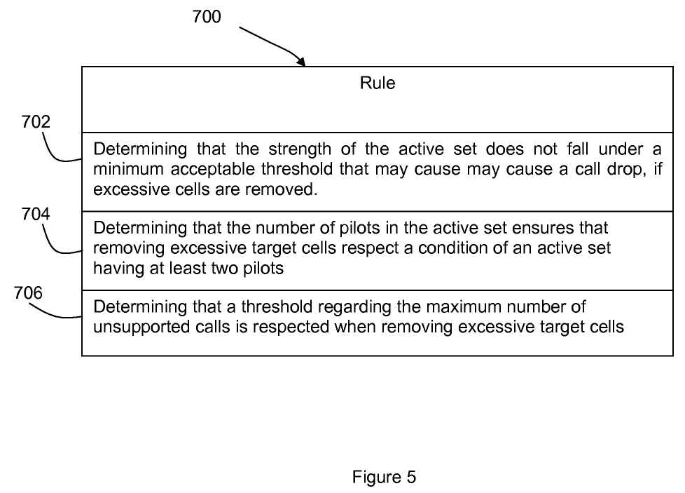

In a particular case, if the maximum number of unsupported calls is equal to zero for the neighbor list (step 614), the RNM 110 determines that all the target cells with at least one calls 231 of the merged NL 308 are not excessive for a source cell (step 690). Otherwise, the RNM 110 processes the merged NL 308 of target cells starting with the target cell having less Call 231 (step 624). In the case of merged NL 308 the RNM 110 starts with target cell 245. The RNM 110 further determines for a target cell in the NL 308 whether the counter Calls 231 is above or equal the threshold for call not supported (step 616). If the counter Calls 231 for a target cell is above or equal to the threshold, the RNM 110 determines that the target cell and the target not evaluated in the merge NL 308 are not excessive (step 690). Otherwise, the RNM 110 processes the HO events 221 in which the target cell was added (618). At step 620, the RNM 110 determines a set of rules for removing the target cell and if these rules are satisfied the target cell is added to the excessive NL 306 (step 622) and the next target cell is evaluated. Otherwise, the target cell is considered not excessive and added in the recommended NL 123 (step 690) and the next target cell is evaluated. Reference is now made to FIG. 5, which is an example of a set of rules for adding a target cell to the excessive NL 306. The list 700 contains rules, while not being limited to, such as a rule affecting the strength of the active set for not falling under a minimum acceptable threshold that may cause a call drop when the excessive cells are removed (702) or a rule affecting the number of pilots in the active set by ensuring that the removal of the excessive cell will not interfere with the operator desire to have two pilots in the active set (704) or a rule for respecting a threshold regarding the maximum number of unsupported calls by ensuring that the total number of calls not supported has not reach this threshold (706). The total calls that are not supported includes the Calls 231 supported by the current target cell under evaluation and the calls from all previously evaluated excessive targets. A CCR is not double-counted if it is supported by multiple excessive targets.

When the RNM 110 determines that a target cell is not excessive, at step 690, the RNM 110 determines if the target cell is present in the current neighbor cell list of the source cell (step 692). The RNM 110 then determines if the target cell is already a neighbor cell of the source. If it is not the case, the processor 113 determines that the target cell is a missing target cell and adds the cell to the source recommended NL 123 (step 694). If it is the case, the RNM 110 keeps the target cell as an existing neighbor cell in the source recommended NL 123 (696).

It can also be understood that some messages and therefore some parameters sent between network elements of the network 200 are omitted for clarity reasons. The network 200 shown in FIG. 1 is only provided as an example. Thus, it can be understood that a BS can alternatively serve more than one cell, the BSC 100 can also serve more than one BS and the radio network manager 110 can also serve more than one BSC 100. As a result, it should also be understood that FIGS. 1 to 5 depict a simplified network 200, and that many other network elements have been omitted for clarity reasons only. Hence, the network 200 may comprise more than one RNM 110. In the same way, the network 200 can be accessed by more than one MS and that a plurality of MSs can access simultaneously the network 200.

For example, the network 200 shown in FIG. 1 can be a multi-frequency network and thus may have cells having more than one communication channel (CCID). In order to allow removing of neighbors from a source cell with more than one communication channel, the source cell confidence level should be high, which is when the communication channel of the source cell is greater or equal to the confidence level threshold and when all communication channels of the neighbor cells should be in the excessive NL. Also, the sorting of the recommended neighbor list for a source, the RNM 110 processes the missing counters for each target cells. Therefore the compilation of missing counters is the total missing counters 227, 228 and 229 of all communication channels of a target cell. Furthermore, the total Calls 231 and total Adds 232 would be the total of Calls 231 and total of Adds 232 of all communication channels of the target cell.

While the invention has been particularly shown and described with reference to the preferred embodiments thereof, it will be understood by those skilled in the art that various alterations may be made therein without departing from the scope of the invention.

What is claimed is:

1. A method for managing a list of target cells associated to a source cell in a telecommunications network, the method comprising the steps of:
receiving at a radio network manager from a base station controller (BSC), a file containing at least one record associated to the source cell;
determining for each record whether a target cell is missing from the list of target cells;
if the target cell is missing from the list of target cells, the radio network manager identifies the target cell as missing from the list of target cells;
determining for each record whether a target cell is excessive from the list of target cells;
if the target cell is excessive from the list of target cells, the radio network manager removes the target cell; and
sending an updated list of target cells for the source cell from the radio network manager to the BSC.

2. The method of claim 1, wherein the method executes the following steps prior the step of receiving:
a) setting a first threshold for a timer;
b) setting a second threshold for maximal size for the file;
c) sending, from a MS to the BSC, data related to the source cell from which the MS is involved in a call;
d) receiving data at the BSC;
e) processing data at the BSC;
f) storing the processed data in a file; and
g) determining, at the BSC, whether the first threshold is reached:
if the value is below or equal to the first threshold:
h) determining, at the BSC, whether the second threshold value is reached:
if the value is above the second threshold, the BSC sends the file to the radio network manager; and
if the threshold value is below the second threshold, the BSC repeats steps a) to h).
if the value is above the first threshold:
the BSC sends the file to the radio network manager.

3. The method of claim 1, wherein the step of receiving further comprises the step of:
storing the file at the radio network manager; and
processing, at the radio network manager, each of the at least one record of the file.

4. The method of claim 1, wherein the step of determining for the at least one record whether the target cell is missing from the list target cells further comprises the steps of:
retrieving a list of target cells for a source cell of each record of the file; and
creating a merged neighbor list containing target cells of cells present in an active set of the source cell.

5. The method of claim 1, wherein the step of sending further includes the steps of:
sorting the list of target cells;
setting a maximal number of target cells in the updated list of target cells; and
reducing the number of target cells in the updated neighbor cell list.

6. The method of claim 1, wherein the step of determining for each record whether a target cell is missing from the list of target cells further comprises the steps of:
incrementing a first missing counter for a pilot of a target cell of the list for which the radio network manager determines that the following conditions are satisfied:
determining that a call failure occurred for a MS when located in the source cell;
determining that the MS has re-originated the call after the call failure within a time limit from a pilot of a target cell that is not a member of the active set of the source cell; and
determining that the pilot is present in data sent from the MS to the BSC.

7. The method of claim 1, wherein the step of determining for each record whether the target cell is missing from the list of target cells further comprises the steps of:
incrementing a second missing counter for a pilot of a target cell of the list for which the radio network manager determines that the following conditions are satisfied:
a) determining that a call failure occurred for a MS when located in the source cell;
b) determining that the MS has re-originated the call after the call failure within a time limit from a pilot of a target cell that is not a member of the active set of the source cell;
c) determining that the pilot is present in data sent from the MS to the BSC; and
d) determining that the power strength of the pilot is above or equal to a predetermined threshold.

8. The method of claim 1, wherein the step of determining for each record whether the target cell is missing from the list of target cells for the source cell further comprises the steps of:
incrementing a second missing counter for a pilot of a target cell of the list for which the radio network manager determines that the following conditions are satisfied:
a) determining that the pilot is present in a message data sent from the MS to the BSC;
b) determining that the active set for the source cell can comprise more than one pilot; and
c) allowing the two strongest pilots to be in the active set.

9. The method of claim 1, wherein the step of removing comprises the steps of:
processing hand off events at the radio network manager;
creating a merged cell list of target cells for the source cell;
processing the merged cell list;
determining that a set of rules for removing the target cell is satisfied; and
adding the target cell to a list of excessive target cells, if the set of rules for removing the target cell is satisfied.

10. The method of claim 9, wherein the step of determining comprises a step of determining that a target cell is non-excessive, if the set of rules for removing the target cell is not satisfied.

11. The method of claim 9, wherein the set of rules for removing an excessive target cell is from a group consisting of:
a) determining that the strength of the active set is over a minimum acceptable threshold for avoiding failure of a call, if the excessive target cell is removed;
b) determining that the number of pilots in the active set ensures that removing the excessive target cell respect a condition of an active set having at least two pilots; and
c) determining that a threshold regarding the maximum number of unsupported calls is satisfied when removing the excessive target cell.

12. The method of claim 9, wherein the step of creating further comprises the steps of:
setting a level of confidence for the source cell;
determining whether a first counter is equal or above the level of confidence:
removing a target cell when a second counter is equal to zero for the target cell, if the first counter is equal or above the level of confidence; and
determining that the target cell is non-excessive, if the first counter is below the level of confidence.

13. The method of claim 12, wherein the further comprises:
setting a threshold for unsupported calls;
determining whether the unsupported calls are equal to zero for a target cell:
if the unsupported call is equal to zero for the target cell, the target cell is non-excessive; and
if the unsupported call is different than zero, processing the merged list starting with a target cell having the lowest second counter.

14. The method of claim 12, wherein the step of removing comprises the steps of processing handoff events for a call during which the target cell was added, determining that the set of rules for removing the target cell is satisfied and adding the target cell to a list of excessive target cells, if the second counter for the processed target cell is below the threshold for unsupported calls.

15. The method of claim 12, wherein the step of determining that the target cell is non-excessive further comprises the steps of:
adding the target cell as a missing target cell in the list of recommended target cells, if the target cell is not already in the neighbor list of the source cell; and
maintaining the target cell in the list of target cells for the source cell, if the target cell is already in the list of target cells of the source cell.

16. A radio network manager for managing a list of target cells associated to a source cell in a telecommunications network, the radio network manager comprising:
an input/output (I/O) unit for receiving a file containing at least one record associated to the source cell from a base station controller (BSC);
a processor for:
determining for each record whether a target cell is missing from the list of target cells;
identifying the target cell as missing from the list of target cells, if the target cell is missing from the list of target cells;
determining for each record whether a target cell is excessive from the list of target cells;
removing the target cell, if the target cell is excessive from the list of target cells; and
sending from the I/O unit an updated list of target cells for the source cell to the BSC.

17. The radio network manager of claim 16, wherein the file is stored at a database and the processor accesses the database for processing each of the at least one record of the file.

18. The radio network manager of claim 16, wherein the processor retrieves a list of target cells for a source cell of each record of the file.

19. The radio network manager of claim 16, wherein the processor creates a merged neighbor list containing target cells of cells present in an active set of the source cell.

20. The radio network manager of claim 17, wherein the processor sorts the list of target cells, sets a maximal number of target cells in the updated list of target cells and reducing the number of target cells in the updated neighbor cell list before sending the updated list to the BSC.

21. The radio network manager of claim 16, wherein the processor increments a first missing counter for a pilot of a target cell of the list for which the processor determines that the following conditions are satisfied:
a) a call failure occurred for a MS when located in the source cell;
b) the MS has re-originated the call after the call failure within a time limit from a pilot of a target cell that is not a member of the active set of the source cell; and
c) the pilot is present in data sent from the MS to the BSC.

22. The radio network manager of claim 16, wherein the processor increments a second missing counter for a pilot of a target cell of the list for which the processor determines that the following conditions are satisfied:
a) a call failure occurred for a MS when located in the source cell;
b) the MS has re-originated the call after the call failure within a time limit from a pilot of a target cell that is not a member of the active set of the source cell;
c) the pilot is present in a message data sent from the MS to the BSC; and
d) the power strength of the pilot is above or equal to a predetermined threshold.

23. The radio network manager of claim 16, wherein the processor increments a third missing counter for a pilot of a target cell of the list for which the processor determines that the following conditions are satisfied:
a) the pilot is present in data sent from the MS to the BSC;
b) determining that the active set for the source cell can comprise more than one pilot; and
c) allowing the first two strongest pilots to be in the active set.

24. The radio network manager of claim 16, wherein the processor processes handoff events stored in the database; creates a merged cell list of target cells for the source cell, processes the merged cell list, determines that a set of rules for removing the target cell is satisfied and adds a target cell to a list of excessive target cells, if the set of rules for removing the target cell is satisfied.

25. The radio network manager of claim 24, wherein the processor determines that a target cell is non-excessive, if the set of rules for removing the target cell is not satisfied.

26. The radio network manager of claim 24, wherein the processor applies a set of rules for removing an excessive target cell from a list of target cells from a group consisting of:
a) determining that the strength of the active set is over a minimum acceptable threshold for avoiding failure of a call, if the excessive target cell is removed;
b) determining that the number of pilots in the active set ensures that removing the excessive target cell respect a condition of an active set having at least two pilots; and
c) determining that a threshold regarding the maximum number of unsupported calls is satisfied when removing the excessive target cell.

27. The radio network manager of claim 24, wherein the processor:
sets a level of confidence for the source cell;
determines whether a first counter is equal or above the level of confidence;
removes a target cell when a second counter is equal to zero for the target cell, if the first counter is equal or above the level of confidence; and
determines that the target cell is non-excessive, if the first counter is below the level of confidence.

28. The radio network manager of claim 27, wherein the processor further:
sets a threshold for unsupported calls;
determines whether the unsupported calls are equal to zero for a target cell:
if the unsupported call is equal to zero for the target cell, the target cell is non-excessive; and
if the unsupported call is different than zero, processes the merged list starting with a target cell having the lowest second counter.

29. The radio network manager of claim 28, wherein the processor processes handoff events for a call during which the target cell was added, determines that the set of rules for removing the target cell is satisfied and adds the target cell to a list of excessive target cells, if the second counter for the processed target cell is below the threshold for unsupported calls.

30. The radio network manager of claim 25, wherein for each non-excessive target cell the processor:
adds the target cell as a missing target cell in the list of recommended target cells, if the target cell is not already in the neighbor list of the source cell; and
maintains the target cell in the list of target cells for the source cell, if the target cell is already in the list of target cells of the source cell.
